(19) United States
(12) Patent Application Publication
(10) Pub. No.: US 2024/0214487 A1
(43) Pub. Date: Jun. 27, 2024

(54) SYSTEM AND METHOD FOR LIMITING MOBILE PHONE USE BY DRIVERS

(71) Applicant: PRANA ENTERPRISE PTY LTD, Rothwell (AU)

(72) Inventor: Dilip Jehtala Mehta, Ferny Hills (AU)

(21) Appl. No.: 18/294,034

(22) PCT Filed: Jul. 18, 2022
(86) PCT No.: PCT/AU2022/050755

§ 371 Date: Jan. 31, 2024

(30) Foreign Application Priority Data
Jul. 16, 2021 (AU) 2021902186

(51) Int. Cl. H04M 1/72463; G07C 5/00; H04M 1/72412; H04M 1/72454

(52) U.S. Cl. CPC H04M 1/724631; G07C 5/008; H04M 1/72412; H04M 1/72454

(57) ABSTRACT

A system for limiting use of an electronic mobile device by a driver of a vehicle. The system includes a mobile device controller system in communication with a vehicle and wireless communication with an electronic mobile device. The mobile device controller system includes a wireless vehicle diagnostic device and a Radio Frequency Identifier (RFID) tag. The system disables select radio frequency signal transmissions of the electronic mobile device in response to receiving the vehicle data from the mobile device controller system, wherein RFID functionality of the electronic mobile device is not disabled. The system requests an input via the RFID Reader of the electronic mobile device that satisfies a predetermined criterion to restore radio frequency signal transmission of the electronic mobile device.

### FIELD OF THE INVENTION

The present invention relates to a system and method for limiting or preventing mobile phone use by a driver while driving a vehicle.

### BACKGROUND

Any references to methods, apparatus or documents of the prior art are not to be taken as constituting any evidence or admission that they formed, or form, part of the common general knowledge.

Using a mobile phone (such as, texting, messaging and phone calls) while driving is known to be a significant contributor to and cause of traffic accidents.

Around the world, thousands of drivers, passengers and pedestrians are injured or lose their lives due to mobile phone use while driving.

The practice of using a mobile phone with your hands has been banned in many countries to address this problem. However, it is difficult for police and law enforcement to monitor such use amongst their various other duties.

While governments invest considerable time and money into developing campaigns to dissuade drivers from using their mobile phones while driving, and law enforcement imposes significant penalties for individuals caught using their phones while driving, the dangerous practice continues.

Simply banning the handheld use of mobile phones while driving and imposing financial penalties appears to have proven insufficient.

Thus, there is a need for a way to limit or prevent drivers from using their mobile phones while driving.

### OBJECT OF THE INVENTION

It is an aim of this invention to provide a system for limiting or preventing use of a mobile phone by driver while driving which overcomes or ameliorates one or more of the disadvantages or problems described above, or which at least provides a useful commercial alternative.

Other preferred objects of the present invention will become apparent from the following description.

### SUMMARY OF THE INVENTION

According to a first embodiment of the present invention there is provided a system for limiting use of an electronic mobile device by a driver of a vehicle, the system comprising: a mobile device controller system in communication with a vehicle and for wireless communication with a or one or more electronic mobile devices, the mobile device controller system comprising a wireless vehicle diagnostic device and a Radio Frequency Identifier (RFID) tag;
wherein the wireless vehicle diagnostic device of the mobile device controller system is configured to communicate with a vehicle, obtain vehicle data and transmit vehicle data to the electronic mobile device; and
a electronic mobile device for wireless communicating with the mobile device controller system, the electronic mobile device comprising:
   an application installed thereon;
   a wireless transceiver configured for wireless communication with the wireless vehicle diagnostic device of the mobile device controller system;
   an RFID reader configured for wireless communication with the RFID tag of the mobile device controller system;
   an electronic mobile device processor programmed to execute one or more instructions of the application stored in a non-transitory computer readable storage medium of the electronic mobile device, wherein the instructions comprise:
      disabling select radio frequency signal transmissions of the electronic mobile device in response to receiving the vehicle data from the mobile device controller system, wherein RFID functionality of the electronic mobile device is not disabled;
      requesting an input via the RFID Reader of the electronic mobile device that satisfies a predetermined criterion;
      receiving the input via the RFID reader that satisfies the predetermined criterion, wherein the predetermined criterion comprises the RFID reader of the electronic mobile device being in communication with the RFID tag of the mobile device controller system; and
      restoring radio frequency signal transmission of the electronic mobile device.

Preferably, the wireless vehicle diagnostic device comprises a Bluetooth vehicle diagnostic device. Preferably, the Bluetooth vehicle diagnostic device of the mobile device controller system is configured to transmit the vehicle data to the electronic mobile device, the vehicle data comprising a vehicle status code obtained from the onboard vehicle computer (or Engine Control Unit—ECU) via the OBDII port of the vehicle. In some embodiments, the Bluetooth vehicle diagnostic device of the mobile device controller system is configured to transmit the vehicle data to the electronic mobile device upon initiation through ignition of the vehicle. Preferably, the Bluetooth vehicle diagnostic device is a Bluetooth-enabled diagnostic tool configured to interface with a vehicle computer via the OBDII port of the vehicle, read vehicle data from the vehicle computer and wirelessly transmit the vehicle information to a smartphone.

Preferably, the mobile device controller system is removably connected to the vehicle.

Preferably, the instructions further comprise monitoring movement of the electronic mobile device, wherein monitoring comprises reading one or more inertial sensors of the electronic mobile device; and in response to detecting movement of the electronic mobile device over a predetermined threshold, the system further comprises restricting or disabling input to the electronic mobile device, wherein disabling or restricting input to the electronic mobile device comprises disabling input via the display or buttons of the electronic mobile device. In some embodiments, in response to detecting movement of the electronic mobile device, a warning or alert is issued from the electronic mobile device. Preferably, the alert may be in the form of an audio alert. Suitably, the audio alert may take the form of a voice recording.

Preferably, radio frequency signal transmission of the electronic mobile device is only restored while the RFID reader is in communication with the RFID tag. Preferably, the instructions further comprise confirming, at predefined intervals, the RFID reader is in communication with the RFID tag. Preferably, in response to detecting that the RFID reader is in communication with the RFID tag, maintaining radio frequency signal transmission of the electronic mobile device. Alternatively, or in addition, in response to detecting that the RFID reader is not in communication with the RFID tag, disabling radio frequency signal transmission of the electronic mobile device. Preferably, in response to detecting that the RFID reader is not in communication with the RFID tag the instructions further comprise determining the status of the vehicle by obtaining a vehicle status code from the Bluetooth vehicle diagnostic device connected to the OBDII port of the vehicle. Preferably, if the vehicle status code indicates the vehicle is active (e.g. engine running and/or engine RPM not zero), the instructions further comprise disabling radio frequency signal transmission of the electronic mobile device. Alternatively, or additionally, if the vehicle status code indicates the vehicle is inactive (e.g. engine not running and/or engine RPM is zero), the instructions further comprise restoring radio frequency signal transmission of the electronic mobile device.

Preferably, in the step of disabling radio frequency signal transmission of the electronic mobile device in response to receiving the vehicle data from the mobile device controller system, the Bluetooth transceiver is disabled. Alternatively, the Bluetooth transceiver is not disabled and is configured to remain in wireless communication with the Bluetooth vehicle diagnostic device of the mobile device controller system.

According to another embodiment of the present invention, there is provided a method for limiting use of a electronic mobile device by a driver of a vehicle, the method including the steps of:
wirelessly associating an electronic mobile device with a mobile device controller system having a wireless vehicle diagnostic device and an RFID tag, the wireless vehicle diagnostic device of the mobile device controller system being configured to communicate with a vehicle, obtain vehicle data and transmit vehicle data to the electronic mobile device;
disabling select radio frequency signal transmissions of the electronic mobile device in response to receiving vehicle data from the wireless vehicle diagnostic device, wherein RFID functionality of the electronic mobile device is not disabled;
requesting an input via the RFID reader of the electronic mobile device that satisfies a predetermined criterion;
receiving the input that satisfies the predetermined criterion from at least one of the one or more electronic mobile devices, wherein the predetermined criterion comprises the RFID reader of the electronic mobile device being in communication with the RFID tag of the mobile device controller system; and restoring radio frequency signal transmission of the electronic mobile device.

Preferably, the RFID tag is an active RFID tag or a passive RFID tag. Preferably, the RFID tag comprises a High Frequency (HF) RFID NFC tag.

Preferably, the mobile device controller system is connected to an Onboard-Diagnostics (OBD) port of a vehicle. Preferably, the OBD port of the vehicle is an OBD-II port. Preferably, the mobile device controller system reads a vehicle status code of the vehicle. Preferably, the vehicle status code is transmitted to or read by the electronic mobile device in wireless communication with the mobile device controller system. Preferably, the vehicle status code initiates the execution of the instructions stored on the electronic mobile device.

Preferably, the method further comprises the step of detecting the vehicle has been turned on before wirelessly associating one or more electronic mobile devices with the mobile device controller system.

Preferably, the system further comprises a passenger (or secondary) RFID device.

Preferably, the application is always active on the electronic mobile device.

Preferably, the mobile device controller system is installed or located on a steering column or dashboard of the vehicle. Preferably, the RFID tag of the mobile device controller system is installed or located on a steering column or dashboard of the vehicle.

Preferably, the system further comprises a mobile phone caddy having the RFID tag thereon, wherein the caddy is configured to receive and hold the electronic mobile device and facilitate wireless communication between the RFID reader of the electronic mobile device and the RFID tag.

Preferably, the system further comprises a vehicle.

Further features and advantages of the present invention will become apparent from the following detailed description.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 illustrates a flow chart of a method for limiting or preventing use of a smartphone by a driver while driving a vehicle;

FIG. 2 illustrates a system for limiting or preventing use of a smartphone by a driver while driving a vehicle;

FIG. 3 illustrates a block diagram of an embodiment of the system shown in FIG. 2, the system having a mobile device controller system in the form of a Bluetooth transceiver; and

FIG. 4 illustrates a flow chart of another method for limiting or preventing use of a smartphone by a driver while driving a vehicle.

### DETAILED DESCRIPTION OF THE PREFERRED EMBODIMENTS

The invention relates to a method and system for limiting mobile phone use by a driver of a vehicle while the vehicle is turned on.

Further to the above, embodiments of the invention are directed to a system and method for prevention of texting or messaging by a driver of a vehicle. The system includes a software application (that is preferably always on or always active) that is installed on a driver's smartphone or similar electronic mobile device, and a mobile device controller which is preferably located on the steering column or dashboard of the driver's vehicle, or built-in to the vehicle's existing componentry. Preferably, the mobile device controller is located in the vehicle such that the driver will always be within range of the device (e.g. in range of the RFID tag) but any passengers will not be within range of the device.

In use, the mobile device controller interfaces or communicates with the smartphone (or other device) when the vehicle is powered on (preferably by at least turning the key to the “accessories” switch) which provides power to the mobile device controller. In response to interfacing or communicating with the mobile device controller, the software application is configured to disable select radio frequency signal transmissions of the electronic mobile device in response to receiving the vehicle data from the mobile device controller system. RFID functionality of the electronic mobile device is not disabled.

Disabling select radio frequency signal transmissions of the electronic mobile device may include enabling “airplane mode” (i.e. disable all outgoing and incoming wireless communication systems such as cellular radios, etc, for example) on the smartphone. In some embodiments, the software application may limit use of specific features and functionalities of the mobile phone (for example, disabling the touch screen or keyboard).

In some embodiments the mobile device controller may be powered by a battery rather than the vehicle itself.

The radio frequency signal transmission of the smartphone can be re-enabled by requesting an input via the RFID Reader of the electronic mobile device that satisfies a predetermined criterion. The predetermined criterion may be satisfied by the user placing the phone in a caddy equipped with an NFC/RFID tag which the smartphone is programmed to read and, as instructed by the software application, re-enable certain wireless communications and functionality of the smartphone. In some embodiments, the software application will then monitor the movement of the smartphone (through the use of inertial sensors located within the smartphone) and disable the radio frequency signal transmission of the smartphone or limit or prevent input through the touchscreen display or buttons to limit and/or prevent illegal use of the smartphone. This is particularly useful if the smartphone is in communication with an NFC/RFID tag that is not embedded within a caddy (in the centre console, for example). In some embodiments, in response to detecting movement of the electronic mobile device, a warning or alert is issued from the electronic mobile device. The alert may be in the form of an audio alert, such as a voice recording instructing whoever has picked up the device (either the driver or a passenger, for example) to return the device to its original position.

Alternatively, detected movement of the smartphone may prompt the software application to check that the smartphone is still in communicable proximity of the NFC tag.

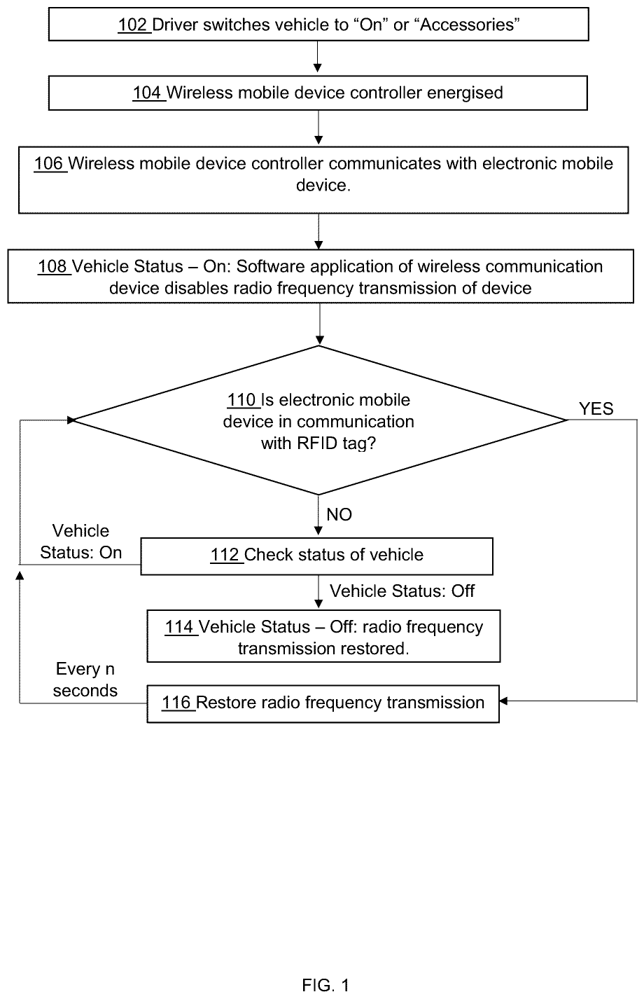

FIG. 1 shows a flow diagram for the steps of a method for limiting the use of a mobile phone or smartphone by a driver of a vehicle.

In Step 102, a driver turns a vehicle on, either to the “Accessories” or “Ignition” switch of the vehicle.

In Step 104, the starting of the vehicle energises or otherwise activates a wireless vehicle diagnostic device of the mobile device controller system located in the vehicle. In the described embodiment, the wireless vehicle diagnostic device takes the form of a Bluetooth vehicle diagnostic device. However, it will be appreciated that the wireless vehicle diagnostic device can be any wireless enabled device capable of interfacing with a vehicle computer (or Engine Control Unit—ECU) and/or vehicle sensors and wirelessly communicating with a smartphone or similar electronic device. The mobile device controller system is such that it is able to wirelessly interface or communicate with a smartphone or similar wireless communication device.

In Step 106, the Bluetooth vehicle diagnostic device of the mobile device controller system interfaces or otherwise communicates with the smartphone of the driver. The smartphone (or similar device) has a software application or mobile application installed thereon. This software application is programmed to recognise communication with the mobile device controller and execute a series of instructions stored in non-transitory computer readable media located within the smartphone. The software application is also programmed to control a number of features and functionalities of the phone which will become clear from the following description. In a particularly preferred embodiment, the software application detects the presence of the Bluetooth vehicle diagnostic device, retrieves the manufacturer/make, model and Vehicle Identification Number (VIN) from the Bluetooth vehicle diagnostic device and displays this information on the screen of the smartphone for the driver. This allows the driver to confirm that the smartphone is connected to the correct Bluetooth vehicle diagnostic device in their vehicle.

In Step 108, the software application, in response to communication with the Bluetooth vehicle diagnostic device of the mobile device controller system, suspends radio-frequency signal transmission by the smartphone (e.g. places the smartphone into “airplane mode”), thereby disabling cellular, Wi-Fi and telephony functionality and devices. In some embodiments, the software application may be programmed to maintain either or both Bluetooth and NFC/RFID functionality. Preferably, RFID/NFC functionality of the smartphone is always maintained to allow the smartphone to interface with an RFID tag. In embodiments where Bluetooth functionality is maintained, the Bluetooth vehicle diagnostic device of the mobile device controller system maintains a constant connection with the smartphone.

In Step 110, the software application requests an input via the RFID Reader of the electronic mobile device that satisfies a predetermined criterion. This includes the software applications instructing the smartphone to check if the smartphone is in wireless communication with an RFID tag (in the form of an NFC tag) which forms part of the mobile device controller system. In a preferable embodiment, the NFC tag is located on the dashboard, centre console or steering column of the vehicle. The inventor has found that the shorter range of NFC tags, as compared to broader RFID tags, is preferable as it ensures the smartphone must remain close to the tag at all times.

If the driver, before beginning to drive the vehicle, places the smartphone in communicable proximity of a RFID tag of the mobile device system controller located within the vehicle, then the method proceeds to Step 116.

At Step 116, in response to receiving the input via the RFID reader that satisfies the predetermined criterion, wherein the predetermined criterion comprises the RFID reader of the electronic mobile device being in communication with the RFID tag of the mobile device controller system, the software application restores radio-frequency signal transmission for the smartphone (e.g. disables airplane mode). In some embodiments, the software application may restore radio frequency signal transmission but limit or disable input via the touchscreen or buttons of the smartphone to prevent driver use while driving. This would allow a driver to observe directions provided by a navigation application or answer calls through the use of a handsfree system of the vehicle but prevent them from texting or conducting other activities through the display of the smartphone.

In some further embodiments, once radio frequency signal transmission is restored, text-based messaging applications will be disabled or prohibited from activation by the software application to prevent drivers from sending texts and messages while driving and thus further encouraging communication and interaction with the smartphone only through handsfree means.

Following restoration of the radio frequency transmission, the method returns to Step 110 and the software application checks for the presence of the RFID tag within communicable proximity using the built-in RFID technology of the smartphone 250 at predefined intervals of time. For example, in one embodiment, the software application checks for the presence of the RFID tag every n seconds, where n is any number greater than 0.

If the smartphone is not in communicable proximity of the RFID tag of the mobile device system controller located within the vehicle, then the method proceeds to Step 112.

At Step 112, the software application instructs the smartphone to check the status of the vehicle by obtaining a status code from the Bluetooth vehicle diagnostic device.

If the status code indicates that the vehicle is currently on or active, the method returns to Step 110 and radio frequency signal transmission is not re-enabled. The checking step of Step 110 is then repeated.

If the status code indicates that the vehicle is currently off or inactive, the method proceeds to Step 114 and the software application restores radio-frequency signal transmission for the smartphone (e.g. disables airplane mode).

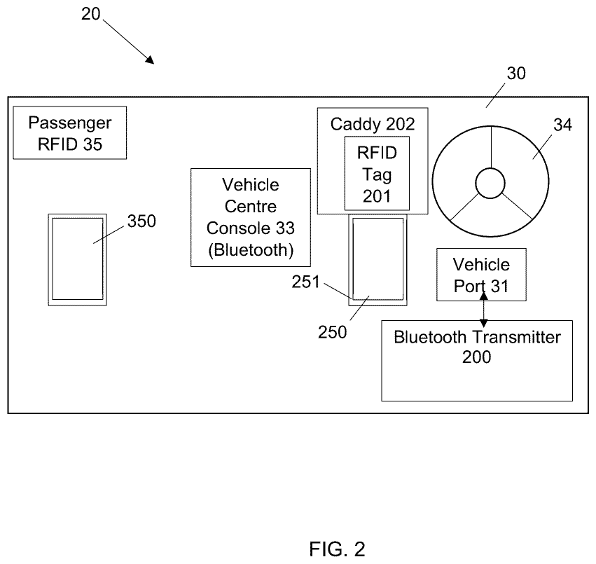

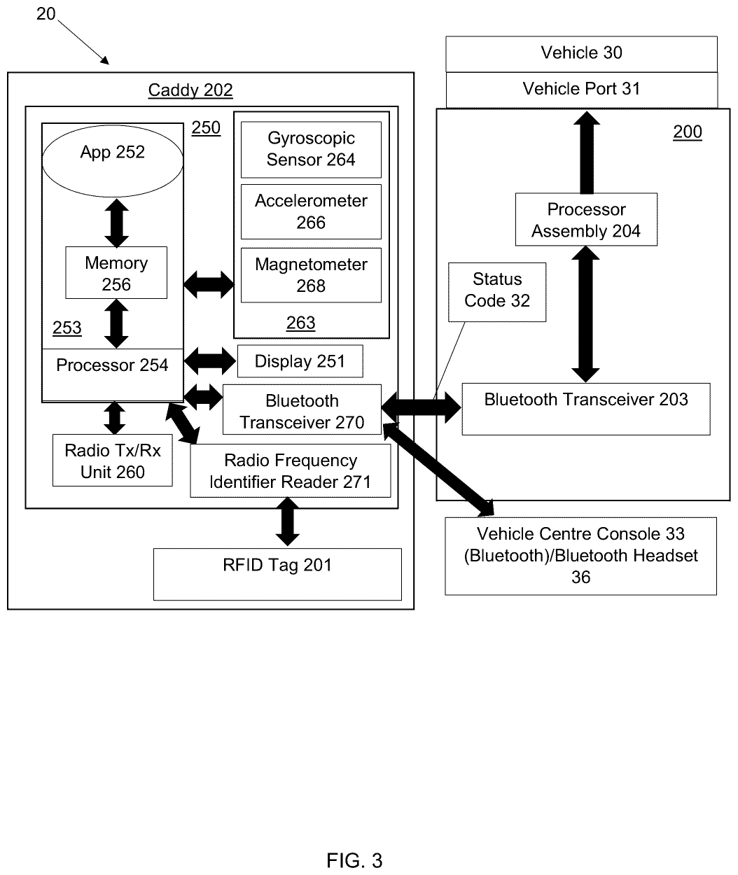

In the illustrated embodiment shown in FIG. 2, there is a system 20 including a mobile device controller system having a Bluetooth vehicle diagnostic device 200 (see FIG. 3) and an RFID tag 201 located in a smartphone supporting caddy 202. The system 20 also includes an electronic mobile device in the form of a smartphone 250 having a display 251. In the illustrated embodiment, the RFID tag 201 takes the form of a High Frequency RFID tag but could be any type of RFID tag.

The radio frequency signal transmission of the smartphone 250 can be re-enabled by the user placing the phone in the caddy 202 equipped with an RFID tag 201 which the smartphone 250 is programmed to read and, as instructed by the software application, re-enable certain wireless communications and functionality of the smartphone 250. In particular, a driver turns a vehicle 30 on, either to the “Accessories” or “Ignition” switch of the vehicle 300.

The starting of the vehicle 30 energises or otherwise activates a wireless vehicle diagnostic device of the mobile device controller system located in the vehicle 30. In the described embodiment, the wireless vehicle diagnostic device takes the form of a Bluetooth vehicle diagnostic device 200 described above.

The Bluetooth vehicle diagnostic device 200 of the mobile device controller system interfaces or otherwise communicates with the smartphone 250 of the driver of the vehicle 30. The smartphone 250 has a software application or mobile application installed thereon. This software application is programmed to recognise communication with the mobile device controller and execute a series of instructions stored in non-transitory computer readable media located within the smartphone 250. As noted above, the software application is programmed to control a number of features and functionalities of the phone which will become clear from the following description.

In response to communication with the Bluetooth vehicle diagnostic device 200 of the mobile device controller system, the software application suspends radio-frequency signal transmission by the smartphone 250 (e.g. places the smartphone into “airplane mode”), thereby disabling cellular, Wi-Fi and telephony functionality and devices. In some embodiments, the software application may be programmed to maintain either or both Bluetooth and NFC functionality. In embodiments where Bluetooth functionality is maintained, the Bluetooth vehicle diagnostic device of the mobile device controller system maintains a constant connection with the smartphone.

The software application instructs the smartphone 250 to check if the smartphone 250 is in wireless communication (or is in communicable proximity with) with an RFID tag 201 which forms part of the mobile device controller system. In the illustrated embodiment, the RFID tag 201 is located in a smartphone caddy 202 which is adapted to receive and the smartphone 250 while the vehicle is in use 30. In a preferable embodiment, the NFC tag is located on the dashboard, centre console or steering column of the vehicle.

If the driver, before beginning to drive the vehicle, places the smartphone in communicable proximity of RFID tag 201 of the mobile device system controller located within the vehicle 30, then the software application restores radio-frequency signal transmission for the smartphone (e.g. disables airplane mode).

Following restoration of the radio frequency transmission, the software application checks for the presence of the RFID tag within communicable proximity using the built-in RFID technology of the smartphone 250 at predefined intervals. For example, the software application may check for the presence of the RFID tag 201 at every n seconds, where n is any number greater than 0.

In some embodiments to be described below, the software application will then monitor the movement of the smartphone 250 (through the use of inertial sensors located within the smartphone 250) and disable the radio frequency signal transmission of the smartphone 250 or limit or prevent input through the touchscreen display 251 or buttons to limit and/or prevent illegal use of the smartphone 250 while the vehicle is in operation. This is particularly useful in embodiments where the smartphone 250 is in communication with an RFID tag 201 that is not embedded within a caddy (in the centre console, for example).

System 20 shows the Bluetooth vehicle diagnostic device 200 of the mobile device controller system connected to vehicle 30 (which is a typical motor vehicle) having a vehicle port 31, preferably an OnBoard Diagnostics Second Generation (OBD-II) port or similar) and a vehicle centre console 33 having built-in Bluetooth capabilities. The connection to vehicle centre console 33 allows the smartphone 250 to be used handsfree via the vehicle's control system. Alternatively, the smartphone 250 may be connected to a handsfree Bluetooth headset 36 worn by the driver or another handsfree Bluetooth device.

As can be seen, the vehicle port 31 is typically below the steering wheel 34. The vehicle port 31 allows the Bluetooth vehicle diagnostic device to provide real time data from vehicle subs-systems. In particular, the OBDII allows the Bluetooth vehicle diagnostic device to read and transmit vehicle status codes from the onboard vehicle computer/ECU and/or vehicle sensors to the smartphone 250. It will be understood that the Bluetooth vehicle diagnostic device 200 is a Bluetooth-enabled diagnostic tool configured to interface with the vehicle computer via the OBDII port of the vehicle, read vehicle information from the vehicle computer and wirelessly transmit the vehicle information to the smartphone 250. Some examples of vehicle information that can be read by the Bluetooth vehicle diagnostic device includes tyre pressure, fuel consumption, average speed, engine on/off, warning lights currently active, engine RPM.

System 20 may also include a passenger RFID 35 in the form of a passive RFID tag that is preferably mounted to the dashboard or storage compartment on the passenger seat side of the vehicle 30.

The passenger RFID 35 performs a similar function to the RFID tag 201 of the mobile device controller system described above. In use, a smartphone 350 (similar to smartphone 250 having an app installed thereon) of a passenger would connect to the Bluetooth vehicle diagnostic device 200 upon ignition of the vehicle 30 which would disable a number of features and functionalities of the smartphone 350 as described above.

In response, the passenger would use an RFID reader of the smartphone 350 to read the passenger RFID tag 35 which would re-enable some or all of the functionality of the smartphone 350 of the passenger.

In some embodiments, the passenger RFID tag 35 may be configured to instruct the software application to cease checking for the presence of any RFID tag to allow the passenger to freely use their smartphone, unlike the driver whose smartphone must be in communication with the RFID tag 201 at all times, or at least at predefined intervals at which the software application checks for the presence of the RFID tag 35 within communicable proximity using the built-in RFID technology of the smartphone 350.

FIG. 3 illustrates a block diagram of the system 20 described above.

The smartphone 250 has a software application (App 252) installed thereon for executing a method in accordance with the steps described above. These steps are stored in non-transitory computer readable media or storage and are executable by the software application when certain conditions or predetermined criteria (as set out above) are satisfied.

The smartphone 250 comprises a microcontroller board 253 which includes a processor 254 that accesses a digital memory 256 that stores app 258 containing instructions to execute the steps of method 100 detailed above.

The microcontroller board 253 also operates radio communications Tx/Rx unit 260 to establish radio communications with a cellular network (not shown) for cellular communication.

The smartphone 250 also includes a motion detecting system 263 in communication with microcontroller board 253. The motion detecting system 263 includes a gyroscopic sensor 264 (such as an electronic gyroscope), an accelerometer 266 and a magnetometer 268.

The mobile 250 also includes a mobile device controller in the form of a Bluetooth transceiver 270 for communicating with a Bluetooth transceiver 203 of Bluetooth vehicle diagnostic device 200.

In the illustrated embodiment in FIG. 3, the Bluetooth vehicle diagnostic device 200 is an aftermarket addition to the vehicle that is installed in a Vehicle Port 31 of vehicle 30, such as an On-Board Diagnostics Port (typically an OBD-II Port) that is present in almost all vehicles produced after 1996. Of course, in some alternative embodiments, the Bluetooth vehicle diagnostic device 200 (or other wireless transmission device) is connected to a 12V DC socket present in the vehicle (such as the cigarette lighter socket or dedicated 12V DC outlet). In some other alternative embodiments, the Bluetooth transceiver is built into the vehicle 30.

In use, the Bluetooth transceiver 203 and processor assembly 203 of Bluetooth vehicle diagnostic device 200 allows the software application 252 to communicate with the Bluetooth transceiver 270 of smartphone 250 and receive/read a signal indicating that the engine of the vehicle is currently turned on. In some embodiments this may be achieved by reading a status code through the OBD-II port. More specifically, the processor assembly 204 of the Bluetooth vehicle diagnostic device 200 interfaces with the vehicle computer via the OBDII port (vehicle port 31) of the vehicle 30, reads vehicle information from the vehicle computer and wirelessly transmits the vehicle information to the smartphone 250 via the Bluetooth Transceiver 203. Some examples of vehicle information that can be read by the Bluetooth vehicle diagnostic device 200 includes tyre pressure, fuel consumption, average speed, engine on/off, warning lights currently active, engine RPM.

As described above, in use, the software application 252 running on the smartphone 250 connects the Bluetooth Transceiver 270 to the Bluetooth transceiver 203 when the driver switches the ignition of the vehicle 30 on (to either the “Accessories” switch or the “Ignition” or “On” switch). The software application 252 may be programmed to automatically detect that the vehicle 30 has been started through the Bluetooth vehicle diagnostic device 200 and disable all radio frequency signal transmission by the smartphone 250 without requiring the driver to activate the app/Bluetooth transceiver 270 of the smartphone 250. Usefully, this means that the driver must always use the software application 252 and cannot selectively avoid using the system and methods described herein to allow them to continue to use their smartphone 250 while driving.

This software application 252 is programmed to recognise communication with the Bluetooth vehicle diagnostic device 200 and execute a series of instructions stored in non-transitory computer readable media located within the smartphone 250. The software application 252 is also programmed to control a number of features and functionalities of the smartphone 250 which will become clear from the following description.

The software application 252, in response to communication with the Bluetooth vehicle diagnostic device 200 of the mobile device controller system, suspends radio-frequency signal transmission by the smartphone 250 (e.g. places the smartphone into “airplane mode”), thereby disabling cellular, Wi-Fi and telephony functionality and devices. In the present embodiment, the software application 252 maintains both Bluetooth and NFC functionality of the smartphone 250. Thus, the Bluetooth vehicle diagnostic device 200 of the mobile device controller system maintains a constant connection with the smartphone 250.

The software application 252 instructs the smartphone 250 to check if the smartphone 250 is in wireless communication with an RFID tag 201 (preferably in the form of an NFC tag) which forms part of the mobile device controller system. In the present embodiment, the RFID tag 201 is located in a caddy 202 adapted to receive and hold the smartphone 250. In other preferable embodiments, the NFC tag is located on the dashboard, centre console or steering column of the vehicle.

If the driver, before beginning to drive the vehicle, places the smartphone 250 in communicable proximity of the RFID tag 201 of the mobile device system controller located within the vehicle 30, then the software application 252 restores radio-frequency signal transmission for the smartphone 250 (e.g. disables airplane mode). In some embodiments, the software application may restore radio frequency signal transmission but limit or disable input via the touchscreen or buttons of the smartphone 250 to prevent physical driver interaction while driving. This would allow a driver to observe directions provided by a navigation application or answer calls through the use of a handsfree system of the vehicle but prevent them from texting or conducting other activities through the display of the smartphone.

If the smartphone 250 is not in communicable proximity of the RFID tag 201 of the mobile device system controller located within the vehicle 30, then the software application 252 instructs the smartphone 250 to check the status of the vehicle 30 by obtaining a status code 32 from the Bluetooth vehicle diagnostic device 200.

If the status code 32 indicates that the vehicle 30 is currently on or active, the software application 252 will not re-enable radio frequency signal transmission of the smartphone 250 and again performs the check of whether the smartphone 250 is in communicable proximity of the RFID tag 201.

If the status code indicates that the vehicle is currently off or inactive, the software application 252 restores radio-frequency signal transmission for the smartphone 250 (e.g. disables airplane mode) to allow hands-on use of the smartphone 250 once again.

In some embodiments, when the smartphone 250 is detected to be in communication with the RFID tag 201 at least once, the software application 252 will then monitor the movement of the smartphone 250 (through the use of inertial sensors of the motion detecting system 263 located within the smartphone 250) and disable the radio frequency signal transmission of the smartphone 250 or limit or prevent input through the touchscreen display 251 or buttons to limit and/or prevent illegal use of the smartphone 250 while the vehicle is in operation. This is particularly useful in embodiments where the smartphone 250 is in communication with an RFID tag 201 that is not embedded within a caddy (in the centre console, for example).

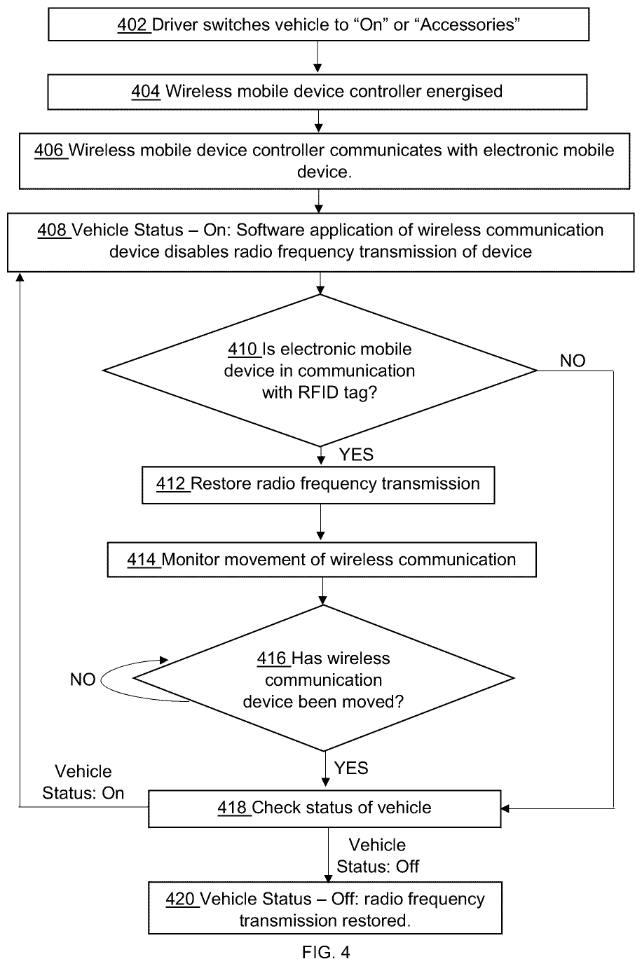

FIG. 4 shows a flow diagram for the steps of another method for limiting the use of a smartphone by a driver of a vehicle. The following embodiment is envisaged to be particularly useful where an RFID or NFC tag is not used with a mobile phone holder or caddy.

In Step 402, a driver turns a vehicle on, either to the “Accessories” or “Ignition” switch of the vehicle.

In Step 404, the starting of the vehicle energises or otherwise activates a wireless vehicle diagnostic device of the mobile device controller system located in the vehicle. In the described embodiment, the wireless vehicle diagnostic device takes the form of a Bluetooth vehicle diagnostic device. However, it will be appreciated that the wireless vehicle diagnostic device can be any wireless enabled device capable of interfacing with a vehicle computer and/or vehicle sensors and wirelessly communicating with a smartphone or similar electronic device. The mobile device controller system is such that it is able to wirelessly interface or communicate with a smartphone or similar wireless communication device.

In Step 406, the Bluetooth vehicle diagnostic device of the mobile device controller system interfaces or otherwise communicates with the smartphone of the driver. The smartphone (or similar device) has a software application or mobile application installed thereon. This software application is programmed to recognise communication with the mobile device controller and execute a series of instructions stored in non-transitory computer readable media located within the smartphone. The software application is also programmed to control a number of features and functionalities of the phone which will become clear from the following description.

In Step 408, the software application, in response to communication with the Bluetooth vehicle diagnostic device of the mobile device controller system, suspends radio-frequency signal transmission by the smartphone (e.g. places the smartphone into “airplane mode”), thereby disabling cellular, Wi-Fi and telephony functionality and devices. In some embodiments, the software application may be programmed to maintain either or both Bluetooth and NFC functionality. In embodiments where Bluetooth functionality is maintained, the Bluetooth vehicle diagnostic device of the mobile device controller system maintains a constant connection with the smartphone.

In Step 410, the software application instructs the smartphone to check if the smartphone is in wireless communication with an RFID tag (in the form of an NFC tag) which forms part of the mobile device controller system. In a preferable embodiment, the NFC tag is located on the dashboard, centre console or steering column of the vehicle.

If the driver, before beginning to drive the vehicle or at any other point in time, places the smartphone in communicable proximity of a RFID tag of the mobile device system controller located within the vehicle, then the method proceeds to Step 412. Otherwise, the method proceeds to Step 419, described below.

At Step 412, the software application restores radio-frequency signal transmission for the smartphone (e.g. disables airplane mode). In some embodiments, the software application may restore radio frequency signal transmission but limit or disable input via the touchscreen or buttons of the smartphone to prevent driver use while driving. This would allow a driver to observe directions provided by a navigation application or answer calls through the use of a handsfree system of the vehicle but prevent them from texting or conducting other activities through the display of the smartphone.

In Step 414, the software application monitors the movement of the smartphone using in-built mobile device controllers of the smartphone. Primarily, the software application will take readings from a motion detecting system of the smartphone including an accelerometer, a magnetometer and a gyroscope of the smartphone to monitor the movement of the smartphone.

In Step 416, the software application determines whether the smartphone has been picked up or moved greater more than a threshold amount. In response, if the smartphone is determined to have been picked up or moved, in Step 418, the software application instructs the smartphone to check the status of the vehicle by obtaining a status code from the Bluetooth vehicle diagnostic device.

If the smartphone is detected as not being moved (i.e. no movement is detected), then Step 416 is repeated and continues to check for movement.

In some embodiments, in response to detecting movement of the smartphone, the software application may either disable radio-frequency signal transmission or limit or disable input into the smartphone (e.g. disable the touch screen/display or keyboard) until the smartphone is put down or docked in a suitable holster or cradle in the vehicle, for example. Alternatively, in response to detecting movement of the electronic mobile device, a warning or alert is generated by the software application and issued. The alert may be in the form of an audio alert, such as a voice recording, instructing whoever moved the smartphone to return the smartphone to its original position (e.g. a handsfree cradle).

If the status code indicates that the vehicle is currently on or active, the method returns to Step 408 and radio frequency signal transmission is once again disabled. The checking step of Step 110 is then repeated.

If the status code indicates that the vehicle is currently off or inactive, the method proceeds to Step 420 and the software application restores radio-frequency signal transmission for the smartphone (e.g. disables airplane mode).

Advantageously, the systems and methods described herein provide a way to discourage, limit and, in some embodiments, prevent use of a mobile phone (or similar device) by a driver of a vehicle that is currently in use.

In this specification, the terms “wireless communication device”, “electronic mobile device”, “smartphone” and “mobile phone” are used substantially interchangeably. Wireless electronic mobile device and electronic mobile device is to be understood to refer to a device used to wirelessly receive and transmit signals and data from one or more sources for the purpose of communication or entertainment. Examples of communication or entertainment includes text messages, data-based messaging services, video streaming services and the like.

In this specification, the phrase “communicable proximity” should be understood to refer to a smartphone (or similar device) being within a suitable distance of an RFID tag such that the two can communicate.

In this specification, adjectives such as first and second, left and right, top and bottom, and the like may be used solely to distinguish one element or action from another element or action without necessarily requiring or implying any actual such relationship or order. Where the context permits, reference to an integer or a component or step (or the like) is not to be interpreted as being limited to only one of that integer, component, or step, but rather could be one or more of that integer, component, or step, etc.

The above detailed description of various embodiments of the present invention is provided for purposes of description to one of ordinary skill in the related art. It is not intended to be exhaustive or to limit the invention to a single disclosed embodiment. As mentioned above, numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. The invention is intended to embrace all alternatives, modifications, and variations of the present invention that have been discussed herein, and other embodiments that fall within the spirit and scope of the above described invention.

In this specification, the terms ‘comprises’, ‘comprising’, ‘includes’, ‘including’, or similar terms are intended to mean a non-exclusive inclusion, such that a method, system or apparatus that comprises a list of elements does not include those elements solely, but may well include other elements not listed.

Throughout the specification and claims (if present), unless the context requires otherwise, the term “substantially” or “about” will be understood to not be limited to the specific value or range qualified by the terms.

1. A system for limiting use of an electronic mobile device by a driver of a vehicle, the system comprising:
a mobile device controller system in communication with a vehicle and for wireless communication with an electronic mobile device, the mobile device controller system comprising a wireless vehicle diagnostic device and a Radio Frequency Identifier (RFID) tag;
wherein the wireless vehicle diagnostic device of the mobile device controller system is configured to communicate with a vehicle, obtain vehicle data and transmit vehicle data to the electronic mobile device; and
a electronic mobile device for wireless communicating with the mobile device controller system, the electronic mobile device comprising:
an application installed thereon;
a wireless transceiver configured for wireless communication with the wireless vehicle diagnostic device of the mobile device controller system;
an RFID reader configured for wireless communication with the RFID tag of the mobile device controller system;
an electronic mobile device processor programmed to execute one or more instructions of the application stored in a non-transitory computer readable storage medium of the electronic mobile device, wherein the instructions comprise:
disabling select radio frequency signal transmissions of the electronic mobile device in response to receiving the vehicle data from the mobile device controller system, wherein RFID functionality of the electronic mobile device is not disabled;
requesting an input via the RFID Reader of the electronic mobile device that satisfies a predetermined criterion;
receiving the input via the RFID reader that satisfies the predetermined criterion, wherein the predetermined criterion comprises the RFID reader of the electronic mobile device being in communication with the RFID tag of the mobile device controller system; and
restoring radio frequency signal transmission of the electronic mobile device.

2. The system according to claim 1, wherein the system further comprises a mobile phone caddy having the RFID tag thereon, wherein the caddy is configured to receive and hold the electronic mobile device and facilitate wireless communication between the RFID reader of the electronic mobile device and the RFID tag.

3. The system according to claim 1, wherein the wireless vehicle diagnostic device comprises a Bluetooth vehicle diagnostic device, the Bluetooth vehicle diagnostic device of the mobile device controller system being configured to transmit the vehicle data to the electronic mobile device.

4. The system according to claim 1, wherein the Bluetooth vehicle diagnostic device of the mobile device controller system is configured to transmit the vehicle data to the electronic mobile device upon initiation through ignition of the vehicle.

5. The system according to claim 1, wherein the Bluetooth vehicle diagnostic device is a Bluetooth-enabled diagnostic tool configured to interface with a vehicle computer via an OBDII (OnBoard Diagnostics II) port of the vehicle, read vehicle data from the vehicle computer and wirelessly transmit the vehicle information to a smartphone.

6. The system according to claim 1, wherein the mobile device controller system is removably connected to the vehicle.

7. The system according to claim 1, wherein the instructions further comprise monitoring movement of the electronic mobile device, wherein monitoring comprises reading one or more inertial sensors of the electronic mobile device; and in response to detecting movement of the electronic mobile device over a predetermined threshold, the system further comprises restricting or disabling input to the electronic mobile device, wherein disabling or restricting input to the electronic mobile device comprises disabling input via the display or buttons of the electronic mobile device.

8. The system according to claim 7, wherein in response to detecting movement of the electronic mobile device, a warning or alert is issued from the electronic mobile device.

9. The system according to claim 1, wherein radio frequency signal transmission of the electronic mobile device is only restored while the RFID reader is in communication with the RFID tag.

10. The system according to claim 1, wherein the instructions further comprise confirming, at predefined intervals, the RFID reader is in communication with the RFID tag.

11. The system according to claim 10, wherein in response to detecting that the RFID reader is in communication with the RFID tag, maintaining radio frequency signal transmission of the electronic mobile device.

12. The system according to claim 10, wherein in response to detecting that the RFID reader is not in communication with the RFID tag, disabling radio frequency signal transmission of the electronic mobile device.

13. The system according to claim 10, wherein in response to detecting that the RFID reader is not in communication with the RFID tag, the instructions further comprise determining the status of the vehicle by obtaining a vehicle status code of the vehicle data from the Bluetooth vehicle diagnostic device connected to the OBDII port of the vehicle, wherein the vehicle status code is obtained from the onboard vehicle computer (or Engine Control Unit—ECU) via the OBDII port of the vehicle.

14. The system according to claim 13, wherein if the vehicle status code indicates the vehicle is active, the instructions further comprise disabling radio frequency signal transmission of the electronic mobile device.

15. The system according to claim 13, wherein if the vehicle status code indicates the vehicle is inactive, the instructions further comprise restoring radio frequency signal transmission of the electronic mobile device.

16. The system according to claim 1, wherein the system further comprises a passenger RFID device.

17. The system according to claim 1, wherein the application is always active on the electronic mobile device.

18. The system according to claim 1, wherein the mobile device controller system is installed or located on a steering column or dashboard of the vehicle.

19. The system according to claim 1, wherein in the step of disabling radio frequency signal transmission of the electronic mobile device in response to receiving the vehicle data from the mobile device controller system, the Bluetooth transceiver is not disabled and is configured to remain in wireless communication with the Bluetooth vehicle diagnostic device of the mobile device controller system

20. A method for limiting use of a electronic mobile device by a driver of a vehicle, the method including the steps of:
wirelessly associating an electronic mobile device with a mobile device controller system having a wireless vehicle diagnostic device and an RFID tag, the wireless vehicle diagnostic device of the mobile device controller system being configured to communicate with a vehicle, obtain vehicle data and transmit vehicle data to the electronic mobile device;
disabling select radio frequency signal transmissions of the electronic mobile device in response to receiving vehicle data from the wireless vehicle diagnostic device, wherein RFID functionality of the electronic mobile device is not disabled;
requesting an input via the RFID reader of the electronic mobile device that satisfies a predetermined criterion;
receiving the input that satisfies the predetermined criterion from at least one of the electronic mobile device, wherein the predetermined criterion comprises the RFID reader of the electronic mobile device being in communication with the RFID tag of the mobile device controller system; and
restoring radio frequency signal transmission of the electronic mobile device.
